(19) United States
(12) Patent Application Publication
(10) Pub. No.: US 2026/0148654 A1
(43) Pub. Date: May 28, 2026

(54) EDUCATIONAL CHALLENGE RESPONSE CLUSTERING AND STATE MACHINE

(71) Applicant: Golden Poppy Inc., Los Altos, CA (US)

(72) Inventors: Carrol Titus, Los Altos Hills, CA (US); Skylar Zambre, Los Altos Hills, CA (US); Yadunath Zambre, Los Altos Hills, CA (US)

(21) Appl. No.: 18/958,886

(22) Filed: Nov. 25, 2024

(51) Int. Cl. G09B 7/04

(52) U.S. Cl. CPC G09B 7/04

(57) ABSTRACT

An educational system utilizes a combination of machine learning models and a state machine for determining a progression classification as a student traverses through a set of educational challenges. The educational system receives a set of markers indicating the student's progress through the set of educational challenges. The educational system generates a set of input vector embeddings representative of the set of markers. Further, the educational system applies a machine learning model to the vector embeddings representative of the progression classifications. The educational system determines a progression classification for the plurality of clusters. The educational system generates for output to the student, an educational program for the next educational state.

### TECHNICAL FIELD

This disclosure generally relates to the field of educational technology, and more particularly relates to use of unsupervised machine learning in tandem with a state machine to drive a student user interface in an educational application.

### BACKGROUND

Where educational challenges cross both traditional modes (e.g., multiple choice questions, written quizzes, etc.) and modern modes (e.g., virtual and augmented reality challenges and/or video game challenges where a task is to be performed by an avatar based on student user instruction), dynamic curation of next educational challenges becomes computationally impractical. For example, where an answer can simply be correct or not correct in traditional modes, a next challenge can be determined on those factors alone. However, where a student user may display knowledge of a principle of physics in a video game, myriad data on progress may be used to measure the level of proficiency for different aspects of the principle (e.g., proper use of drag and thrust to achieve an objective). Collecting all of the collectable data and applying it to a computer for processing yields substantial latency that prevents progression from one challenge to the next, in that it may take minutes or hours to determine a next challenge based on the student user's assessed proficiency. This burden on computational components is computationally expensive and inhibits practical implementation.

### SUMMARY

In some embodiments disclosed herein, an educational system utilizes a combination of machine learning models and a state machine for determining a progression classification as a student traverses through a set of educational challenges. With this approach, myriad data can be mapped using minimal processing power to any number of possible states that drive a progression to a next educational challenge. The educational system receives a set of markers indicating the student's progress through the set of educational challenges. The educational system generates a set of input vector embeddings representative of the set of markers. Further, the educational system applies a machine learning model to the vector embeddings representative of the progression classifications. The educational system determines a progression classification for the plurality of clusters. The educational system generates for output to the student, an educational program for the next educational state.

### BRIEF DESCRIPTION OF THE DRAWINGS

FIG. 1 illustrates one embodiment of a system environment for implementing an educational system, in accordance with one or more embodiments.

FIG. 2 illustrates one embodiment of exemplary modules and databases used by the educational system, in accordance with one or more embodiments.

FIG. 3A illustrates an example of a set of educational challenges a student may progress through an online game, in accordance with one or more embodiments.

FIG. 3B illustrates an example of a set of virtual reality (VR) educational challenges a student may progress through a VR game, in accordance with one or more embodiments.

FIG. 4 illustrates an example of the set of markers extracted by a marker extraction module for an exemplary challenge, in accordance with one or more embodiments.

FIG. 5A is an example of determining a progression classification for a set of students, in accordance with one or more embodiments.

FIG. 5B illustrates an example of determining a next educational state based on the received classification of the student's progression, in accordance with one or more embodiments.

FIG. 6 is a flowchart for a method of an educational system 140 in accordance with some embodiments.

### DETAILED DESCRIPTION

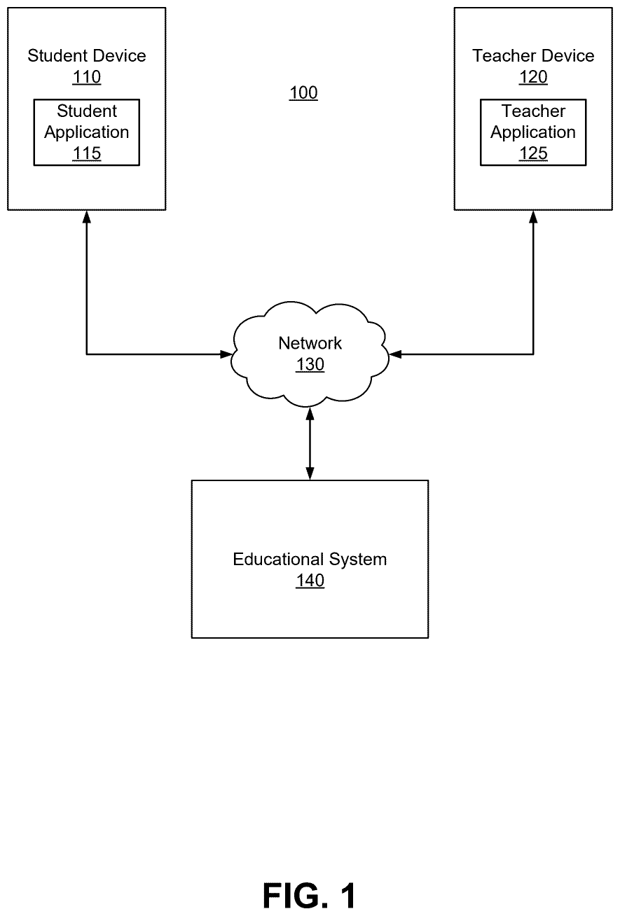

FIG. 1 illustrates one embodiment of a system environment for implementing an educational application, in accordance with an embodiment. As depicted in FIG. 1, environment 100 includes student device 110 (with application 115 installed thereon), teacher device 120 (with application 125 installed thereon), network 130, and educational system 140. While only one instance of each item is depicted, this is for illustrative convenience, and references in the singular to each item is meant to cover instances where plural items exist.

Student device 110 is a device with which a student may interface with an educational system 140. Student device 110 may be any device having a user interface and capable of communication via the network 130. For example, student device 110 may be a personal computer, laptop, tablet, wearable device, kiosk, smart phone, or any other device having components capable of performing the functionality disclosed herein.

Optionally, student device 110 may have application 115 installed thereon. Student application 115 may provide an interface between student device 110 and educational system 140. Student application 115 may be a stand-alone application installed on student device 110 that is communicatively coupled with educational system 140 (via network 130) to perform at least some of the activity described with respect to educational system 140 on student device 110, or may be accessed by way of a secondary application, such as a browser application. Any activity described herein with respect to the educational system 140 may be performed wholly or in part (e.g., by distributed processing) by application 115. That is, while activity is primarily described as performed in the cloud by educational system 140, this is merely for convenience, and all of the same activity may be performed wholly or partially locally to student device 110 by application 115. Exemplary activity of application 115 may include providing a user interface to a student that outputs prompts to the student, receives responses, and transmits those responses for further processing by the educational system 140.

Teacher device 120 is a device with which a teacher or expert educator may interface with the educational system 140. Teacher device 120 may be any device having a user interface and capable of communication via the network 130. For example, teacher device 120 may be a personal computer, laptop, tablet, wearable device, kiosk, smart phone, or any other device having components capable of performing the functionality disclosed herein.

Teacher device 120 may have application 125 installed thereon. Teacher application 125 may provide an interface between teacher device 120 and educational system 140. Teacher application 125 may be a stand-alone application installed on teacher device 120 that is communicatively coupled with educational system 140 (via network 130) to perform at least some of the activity described with respect to educational system 140 on teacher device 120, or may be accessed by way of a secondary application, such as a browser application. Any activity described herein with respect to the educational system 140 may be performed wholly or in part (e.g., by distributed processing) by application 125. That is, while activity is primarily described as performed in the cloud by educational system 140, this is merely for convenience, and all of the same activity may be performed wholly or partially locally to teacher device 120 by application 125. Exemplary activity of application 125 may include providing a user interface to a teacher that outputs prompts to the teacher, receives responses, and transmits those responses for further processing by the educational system 140. The same or a different user interface may also output data and analytics.

Network 130 facilitates transmission of data between student device 110, teacher device 120, and educational system 140, as well as any other entity with which any entity of environment 100 communicates. Network 130 may include any data conduit, including the Internet, short-range communications, a local area network, wireless communication, cell tower-based communications, or any combination of these or other communications channels. Additionally, teacher device 120 or student device 110 may communicate via network 130 with an educational system 140.

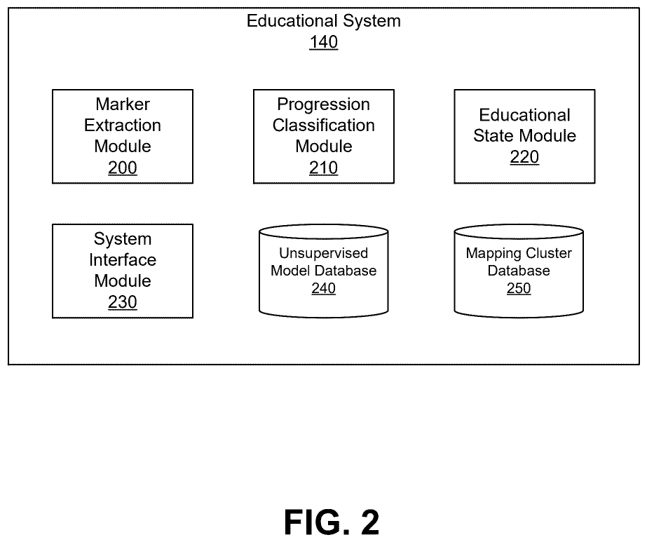

Educational system 140 receives inputs from one or more users of student device 110 or teacher device 120 and processes those inputs to provide progression classifications. Educational system 140 may have its functionality distributed across any number of servers, and may have some or all functionality performed local to student devices 110 (using application 115) or teacher devices 120 (using application 125). Further details about the educational system 140 are disclosed below with respect to FIGS. 2-7.

FIG. 2 illustrates one embodiment of exemplary modules and databases used by the educational system, in accordance with an embodiment. As depicted in FIG. 2, educational system 140 may include marker extraction module 200, progression classification module 210, educational state module 220, system interface module 230, unsupervised model database 240, and mapping cluster database 250. The modules and databases depicted in FIG. 2 are merely exemplary; fewer or additional modules and/or databases may be used to achieve the functionality disclosed herein.

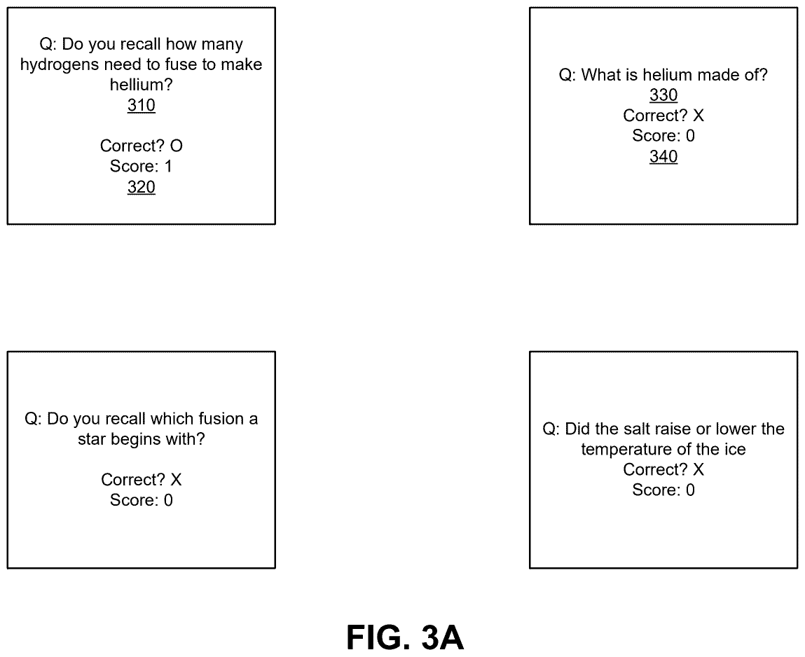

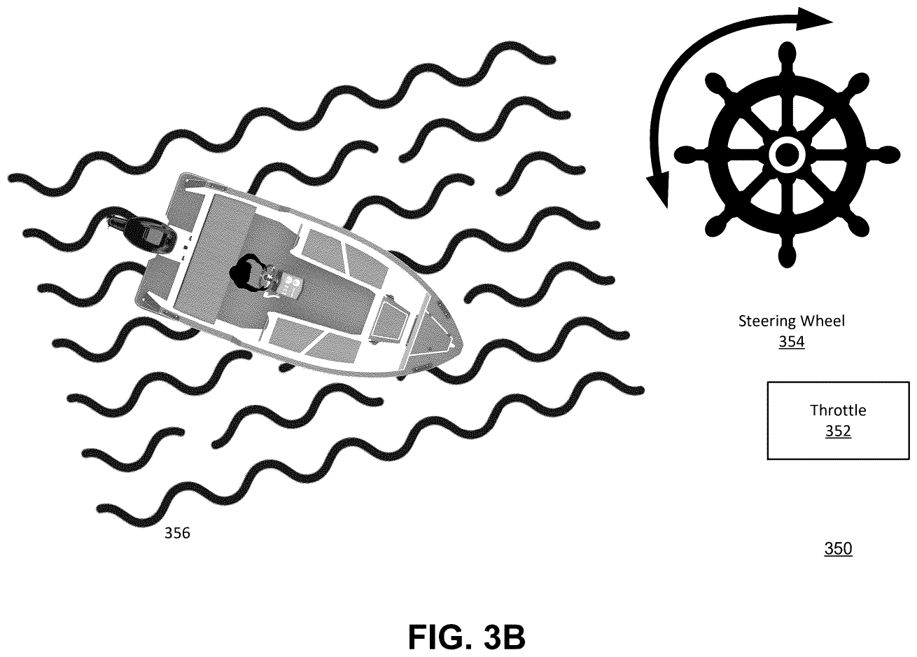

A student accesses the educational system 140 by accessing via the student application 115. In one embodiment, the student initiates a set of educational challenges through a virtual world after accepting a fantasy challenge or quest. In another embodiment, the student initiates a set of educational challenges through an online game (via the educational system 140) after accepting an online challenge or quest. An educational challenge is a structured learning task or activity designed to test and enhance the student's understanding of specific educational content. Educational challenges may be of any type, including classical multiple choice and natural language questions and including more modern educational challenges in a virtual space, such as a video game on a monitor, a virtual reality challenge, an augmented reality challenge, and any combination thereof. Turning briefly to FIG. 3A for illustration, FIG. 3A illustrates a set of educational challenges the student may progress through an online game, in accordance with one or more embodiments.

FIG. 3A illustrates a set of educational challenges the student may progress through an online game, in accordance with one or more embodiments. A student may be presented with a set of educational challenges and prompted to correctly answer questions related to the online challenge. As an example, the student is prompted with a question 310 of “Do you recall how many hydrogens need to fuse to make helium?” wherein which the educational system 140 notes whether the student answered correctly and the student's score 320 (e.g., Correct? O, Score: 1) while traversing the online game. Continuing the example, the student incorrectly answers a second challenge: “What is helium made of?” 330, wherein the student's score 340 is updated accordingly (e.g., Correct? X, Score: 0).

As another example, one or more aspects of the present disclosure relate to a virtual reality (VR) game system. In some implementations, the virtual reality gaming system comprises one or more processors configured to execute computer program modules. In some implementations, the computer program modules of the educational system 140 are configured to facilitate a student challenge through both a virtual environment and a physical environment. For instance, a student may progress in a virtual environment through these set of challenges by using a set of physical clue objects from the physical environment. FIG. 3B illustrates an example of a set of educational challenges the student may progress through in a VR gaming system. Some implementations input movement data of a virtual student's movement in the virtual environment and output information indicating a virtual world location and movement of an avatar of the student. In some implementations, a graphic overlay may be superimposed onto an image of the student in response to a notification from the educational system 140 that the student has completed the challenge.

FIG. 3B illustrates a set of VR educational challenges the student may progress through a VR game, in accordance with one or more embodiments. The educational system 140 presents a set of VR educational challenges and prompts the student to correctly address the educational challenge. Specifically, in FIG. 3B, the virtual environment 350 depicts a ship 356 flowing along a current (e.g., 5 mi/hr) with a steering wheel 354 and throttle 352 to steer and drive the ship. As an example, the educational system 140 may prompt a student to adjust the throttle or steering wheel to navigate ship 356 in a certain path, avoiding obstacles.

Returning to FIG. 2, as a student progresses through each challenge, the marker extraction module 200 extracts a set of markers. A marker includes data reflecting activity of a student in connection with one or more challenges. The marker extraction module 200 monitors for markers to extract as the student engages with each challenge.

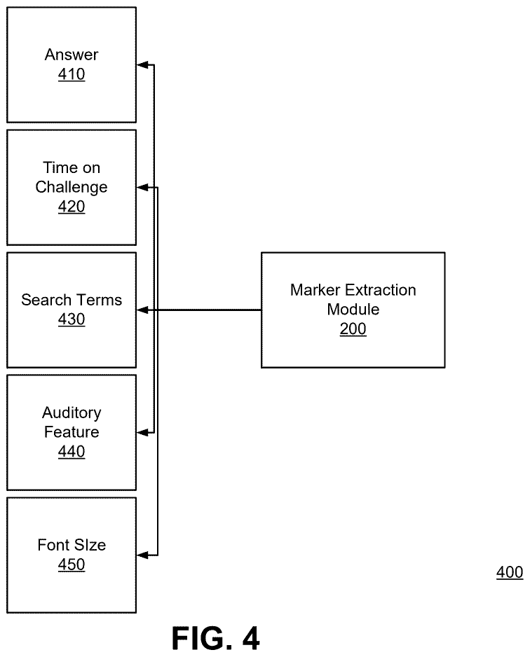

In order to illustrate markers that may be extracted, we turn to FIG. 4. FIG. 4 illustrates an example of the set of markers extracted by the marker extraction module 200 for an exemplary challenge, in accordance with one or more embodiments. In FIG. 4, the educational system 140 extracts a set of markers 400. Markers 400 are not limiting, and any form of marker may be received whether or not contemplated in FIG. 4. For example, the marker extraction module 200 receives the student's answer 410 during the educational challenge and may extract markers from the answer, such as whether the answer is correct or incorrect and any other data about the answer (e.g., passing the answer to a large language model and receiving an indication from the large language model that the answer shows a higher than average level of proficiency). As another example, the marker extraction module 200 records the time 420 the student took between receiving the educational challenge and answering the educational challenge (e.g., which may provide insight on the student's comprehension of the educational challenge). The marker extraction module 200 may record whether a student used a search feature (e.g., extrinsic search for additional information outside of and/or embedded within the educational environment) within the educational challenge and logs the specific search term 430 searched (e.g., which may provide insight of the student's understanding of the term). The marker extraction module 200 may record whether a student used an audio feature 440 within the educational challenge to read-aloud the educational challenge (e.g., which may provide insight of the student's learning style or may be indicative of a reading comprehension issue). The marker extraction module 200 may also record whether a student adjusted the font size 450 of the educational challenge (e.g., which may provide insight into the student's preferred learning style or be indicative of poor eyesight).

The marker extraction module 200 may additionally extract markers from educational challenges. For example, metadata relating to educational challenges (e.g., topic, source, standard responses, etc.) may be extracted as additional markers.

In one embodiment, the marker extraction module 200 extracts a set of markers in a VR environment. VR avatar controls (not depicted in FIG. 4, but a marker in a VR rather than traditional question/answer environment) are markers that may be extracted in the VR environment. For example, the marker extraction module 200 may extract from the virtual environment shown in FIG. 3B, the time taken by the student between receiving and responding to the educational challenge (e.g., time required to steer the ship correctly), providing insights into the student's comprehension of the challenge. As an example, the marker extraction module 200 may extract whether a student properly steered the ship within the virtual environment, sharing insight of the student's comprehension. As another example, the marker extraction module 200 may extract whether a student properly avoided obstacles while steering the ship within the virtual environment of FIG. 3B, sharing insight of the student's comprehension and hand-eye coordination.

Returning to FIG. 2, a progression classification module 210 receives the set of markers from the marker extraction module 200, and uses the set of markers to determine a progression classification of the student. The progression classification module 210 accesses an embedding model (e.g., stored in unsupervised model database 240) to generate an input vector comprised of embeddings representative of each marker of the identified set of markers. The progression classification module 210 inputs the input vector into an unsupervised machine learning model from the unsupervised model database 240. The unsupervised machine learning model may be any clustering model, such as a nearest neighbor search model, a k-means model, or any other unsupervised machine learning model. The progression classification module 210 receives, as output from the unsupervised machine learning model, a coordinate or a set of coordinates in latent space that is representative of the set of identified markers. Additionally or alternatively, the progression classification module 210 may receive an indication of a cluster (e.g., and/or its corresponding set of coordinates) to which the coordinate corresponds from the unsupervised machine learning model.

The progression classification module 210 determines, based on the coordinate of the student (e.g., where a cluster is not output by the unsupervised machine learning model), a classification for progress of the student during a given challenge. In an embodiment, the progression classification module 210 determines a progression label based on a mapping of the coordinate representative of the set of identified markers to a given cluster of a plurality of clusters generated using historical data.

The unsupervised machine learning model identifies or labels a plurality of student's progression through the educational challenge. The unsupervised machine learning model gathers historical student marker data from a plurality of students progressing through identical or substantially similar challenges. For each historical student data, the unsupervised machine learning model vectorizes the student's marker data (e.g., by concatenating the markers), and generates a vector that represent coordinates in a latent space (e.g., by generating latent space embeddings using a neural network). The unsupervised machine learning model maps these coordinates onto the latent space, and then identifies and groups similar data points across the plurality of historical student marker data using a clustering model (e.g., k-means, nearest neighbor search, etc.). Each identified cluster, representing a distinct label of the student's performance, is subsequently labeled by an expert according to its characteristics. The unsupervised machine learning model may cause the system interface 230 to prompt an expert educator to label a cluster according to its characteristics. As an example, the educator may determine, based on its characteristics, that a cluster represents a student's lack of understanding in a concept (e.g., “balancing equations”, “fractions”, “Newton's 1^{st} Law of Motion”). As another example, the educator may determine, based on its characteristics, a cluster to be representative of a student's learning style (e.g., “visual learning”, “auditory learning”, “kinesthetic, physical learning”), to be representative of required remediation (e.g., struggles with reading comprehension), or any other label deemed suitable by the expert. Labels applied by experts may be stored using mapping cluster database 250. After the labels are applied, the model is trained to associate a student's activity vector as new data is obtained when a student engages with a challenge with the corresponding cluster label based on its position in the latent space. In one embodiment, the unsupervised machine learning model may be trained to associate a cluster label based on a nearest cluster for a threshold maximum distance between the cluster and the coordinates. The unsupervised machine learning model enables real-time classification of a student's progress, assigning each student with a classification that reflects the student's progression.

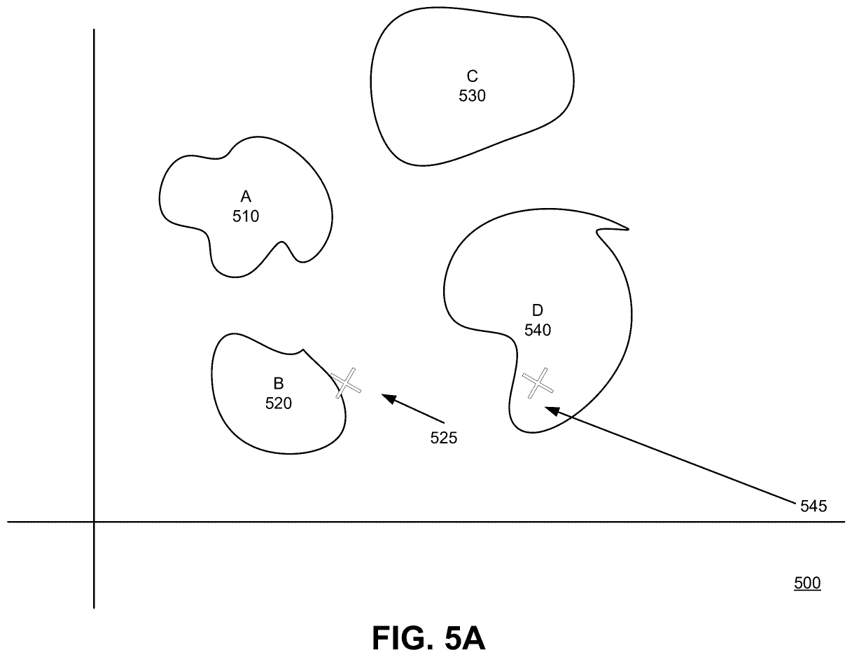

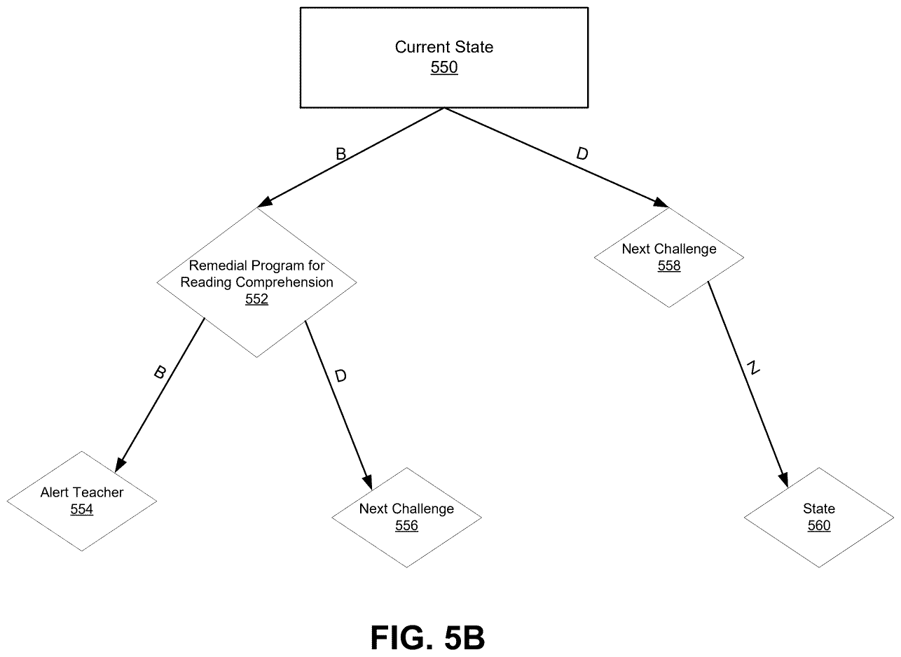

FIG. 5A is an example of determining a progression classification for a set of students based on a mapping of the coordinates to a plurality of clusters, in accordance with one or more embodiments. In FIG. 5A, a classroom of students are prompted to answer via the interface system 230 on questions regarding Newton's First Law of Motion. The students are prompted a question via the system interface system 230 with a text prompt to “Define Inertia:.” The interface system 230 may also display auditory help buttons and search terms (e.g., for definitions, extrinsic information, etc.) within the UI of the question to the student. The interface system 230 receives the text response from the student. A first student's coordinate 545 as determined by the progression classification module 210 map to cluster D 540 for “Great Understanding of Concept.” As another example, a second student's coordinates 525 as determined by the progression classification module 210 do not properly map to a pre-determined cluster (e.g., by referencing mapping cluster database 250). In an embodiment, the system interface module 230 alerts the educational system 140 (e.g., to determine whether the cluster B should be adjusted or whether a new cluster should be labeled by an expert). In an embodiment, the educational system 140 may alert an expert educator or teacher. In an embodiment, the system interface module 230 may assign the student with a nearest cluster classification (e.g., Cluster B 520 for “Auditory Learner”) given that cluster B is nearest to coordinate 525.

The system interface module 230 may provide an interface between teacher device 120, student device 110, and/or educational system 140. The system interface module 230 may include providing a user interface to a teacher (e.g., for monitoring student progress and/or performing an intervention), student (e.g., to provide challenges and enable the student to interface with the challenges, complete the challenges, seek help, etc.), and/or educational system 140 (e.g., to provide alerts where new clusters may need to be labeled, etc.). The term “intervene” and “intervention,” where used herein, may refer to any activity taken by a teacher with respect to a student responsive to an alert to intervene. For example, an alert to intervene may include a selectable option to initiate a communications session (e.g., chat, video, etc.) with a student, or may be a suggestion to the teacher to in any manner deemed suitable by the teacher to be in touch with the student. Remedial programming and/or challenges, on the other hand, refers to educational content presented based on a classification of a student on a given challenge.

The educational state module 220 receives the progression classification from the progression classification module 210 to determine an educational programming for a next state of educational states. The educational states are connected by a state machine, wherein which the state machine includes state nodes and directional edges. The state nodes represent an educational programming. The directional edges point to a next state node, annotated with one or more conditions that, when satisfied, cause the state machine to select the next state node corresponding to the satisfied edge. The educational programming may be one or more of a new challenge, a suggestion to the student, or an adjustment of the student's current device (e.g., increasing font size, increasing volume, etc).

FIG. 5B illustrates an example of determining a next educational state based on the received classification of the student's progression, in accordance with one or more embodiments. FIG. 5B represents a state machine with a current state 550 in which a next state B 552 corresponds to the received classification of the student's progression. Following from the example described with respect to FIG. 5A where classification B is labeled by an expert to correspond to auditory learning (e.g., a student only makes progress after selecting the “Read it out loud” button during a challenge), and state D is labeled to correspond to an understanding of the tested concept, state 550 may progress to a remedial program for reading comprehension 552 where a student is classified with B (e.g., as pre-defined using a state machine), and may progress to a next challenge state 558 where a student is classified with D. Should the student be classified with reading comprehension issues B again after the remedial program, the state machine may progress to state 554 where a teacher is alerted to intervene and provide personal attention to the student. Where the student shows a good understanding of the remedial materials in remedial programming with a classification of D, the state may progress to state 556 where a next challenge is presented to the student. Similarly, where the student initially is classified as having a good understanding with classification D, the state machine may transition the student to state 558 where a next challenge is presented, and depending on how the student progresses through the next challenge, further states (e.g., a state 560 corresponding to a classification of Z) may be used to determine what occurs next. Any number of state machines may be developed for any number of scenarios. For example, a given set of challenges may have a state machine developed for it, such as a standardized educational content with a standardized state machine for progressing through that content. State machines may be developed on a per-student basis, on a category-of-student basis (e.g., A students, B students, C students, etc. may have different state machine for a given curriculum), on a classroom basis, or on any other basis.

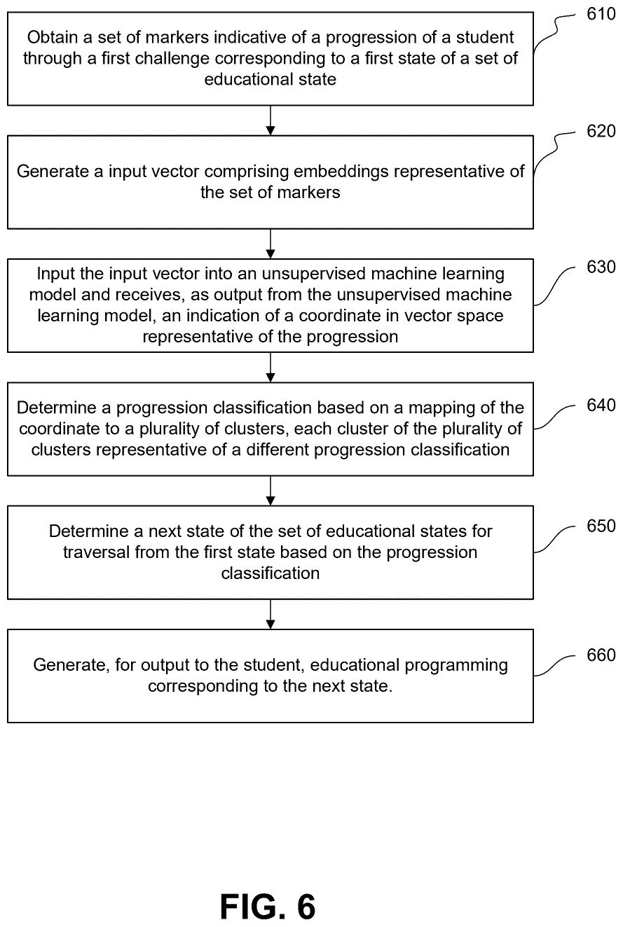

FIG. 6 is a flowchart for a method of an educational system 140 in accordance with some embodiments. Alternative embodiments may include more, fewer, or different steps from those illustrated in FIG. 6, and the steps may be performed in a different order from that illustrated in FIG. 6. Additionally, each of these steps may be performed automatically by educational system 140 without human intervention. A marker extraction module 200 obtains 610 a set of markers indicative of a progression of a student through a first challenge corresponding to a first state of a set of educational states. The marker extraction module 200 generates 620 an input vector comprising embeddings representative of the set of markers. The progression classification module 210 inputs 630 the input vector into an unsupervised machine learning model and receives, as output from the unsupervised machine learning model, an indication of a coordinate in vector space representative of the progression. The progression classification module 210 determines 640 a progression classification based on a mapping of the coordinate to a plurality of clusters, each cluster of the plurality of clusters representative of a different progression classification. The educational state module 220 determines 650 a next state of the set of educational states for traversal from the first state based on the progression classification. The educational state module 220 generates 660, for output to the student via the interface system module 230, an educational programming corresponding to the next state.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising:
obtaining a set of markers indicative of a progression of a student through a first challenge corresponding to a first state of a set of educational states;
generating a input vector comprising embeddings representative of the set of markers;
inputting the input vector into an unsupervised machine learning model and receiving, as output from the unsupervised machine learning model, an indication of a coordinate in vector space representative of the progression;
determining a progression classification based on a mapping of the coordinate to a plurality of clusters, each cluster of the plurality of clusters representative of a different progression classification;
determining a next state of the set of educational states for traversal from the first state based on the progression classification; and
generating, for output to the student, educational programming corresponding to the next state.

2. The method of claim 1, wherein the output may be one or more of a new challenge, a suggestion to the student, or an adjustment of the student's device (e.g., increasing font size, increasing volume, etc).

3. The method of claim 1, wherein the educational states are connected by a state machine, the state machine comprising:
state nodes representative of corresponding educational programming, and
directional edges, each edge of the edges pointing to a next state node and annotated with one or more conditions that, when satisfied, cause the state machine to select the next state node corresponding to the satisfied edge.

4. The method of claim 1, wherein the plurality of clusters are determined by:
inputting historical examples of a plurality of students'progress through the first challenge into the unsupervised machine learning model; and
receiving, as output from the unsupervised machine learning model, indications of clusters of coordinates corresponding to the historical examples.

5. The method of claim 4, wherein a model is trained to output the progression classification by receiving, from an expert user, a label of a given progression classification for each cluster of the plurality of clusters.

6. The method of claim 5, wherein the progression classification is determined to be a given label based on the coordinate being within a cluster having the given label as labeled by the expert user.

7. The method of claim 5, wherein the progression classification is determined to be unknown based on the coordinate not being within any cluster of the plurality of clusters.

8. The method of claim 6, wherein responsive to detecting that the progression classification is unknown, the method further comprises alerting an administrator that a new coordinate space needs review by an expert for labeling.

9. The method of claim 6, wherein responsive to detecting that the progression classification is unknown, the method further comprises transmitting an alert to a teacher of the student to provide an intervention.

10. The method of claim 6, wherein the method further comprises responsive to detecting that the progression classification is unknown, classifying the unknown progression classification to have a given progression classification of a nearest cluster.

11. A non-transitory computer-readable storage medium storing computer instructions, the computer instructions, when executed by one or more processors, cause the one or more processors to perform operations, the instructions comprising instructions to:
obtain a set of markers indicative of a progression of a student through a first challenge corresponding to a first state of a set of educational states;
generate a input vector comprising embeddings representative of the set of markers;
input the input vector into an unsupervised machine learning model and receiving, as output from the unsupervised machine learning model, an indication of a coordinate in vector space representative of the progression;
determine a progression classification based on a mapping of the coordinate to a plurality of clusters, each cluster of the plurality of clusters representative of a different progression classification;
determine a next state of the set of educational states for traversal from the first state based on the progression classification; and
generate, for output to the student, educational programming corresponding to the next state.

12. The non-transitory computer-readable storage medium of claim 11, wherein the educational states are connected by a state machine, the state machine comprising:
state nodes representative of corresponding educational programming, and
directional edges, each edge of the edges pointing to a next state node and annotated with one or more conditions that, when satisfied, cause the state machine to select the next state node corresponding to the satisfied edge.

13. The non-transitory computer-readable storage medium of claim 11, wherein the instructions to determine the plurality of clusters comprise instructions to:
input historical examples of a plurality of students'progress through the first challenge into the unsupervised machine learning model; and
receive, as output from the unsupervised machine learning model, indications of clusters of coordinates corresponding to the historical examples.

14. The non-transitory computer-readable storage medium of claim 13, wherein a model is trained to output the progression classification by receiving, from an expert user, a label of a given progression classification for each cluster of the plurality of clusters.

15. The non-transitory computer-readable storage medium of claim 14, wherein the progression classification is determined to be a given label based on the coordinate being within a cluster having the given label as labeled by the expert user.

16. The non-transitory computer-readable storage medium of claim 14, wherein the progression classification is determined to be unknown based on the coordinate not being within any cluster of the plurality of clusters.

17. The non-transitory computer-readable storage medium of claim 15, wherein the instructions to detect that the progression classification is unknown comprise instructions to:
alert an administrator that a new coordinate space needs review by an expert for labeling.

18. The non-transitory computer-readable storage medium of claim 15, wherein the instructions to detect that the progression classification is unknown comprise instructions to:
transmit an alert to a teacher of the student user to provide an intervention.

19. The non-transitory computer-readable storage medium of claim 15, wherein the instructions to detect that the progression classification is unknown comprise instructions to:
classify the unknown progression classification to have a given progression classification of a nearest cluster.

20. A computer system comprising:
one or more processors; and
a non-transitory computer readable storage medium storing instructions that, when executed by the one or more processors, cause the one or more processors to perform operations comprising:
obtaining a set of markers indicative of a progression of a student through a first challenge corresponding to a first state of a set of educational states;
generating a input vector comprising embeddings representative of the set of markers;
inputting the input vector into an unsupervised machine learning model and receiving, as output from the unsupervised machine learning model, an indication of a coordinate in vector space representative of the progression;
determining a progression classification based on a mapping of the coordinate to a plurality of clusters, each cluster of the plurality of clusters representative of a different progression classification;
determining a next state of the set of educational states for traversal from the first state based on the progression classification; and
generating, for output to the student, educational programming corresponding to the next state.
